(19) United States
(12) Patent Application Publication
(10) Pub. No.: US 2022/0129081 A1
(43) Pub. Date: Apr. 28, 2022

(54) CONTROLLER AND METHOD FOR GESTURE RECOGNITION AND A GESTURE RECOGNITION DEVICE

(71) Applicants: Robert Bosch GmbH, Stuttgart (DE); Robert Bosch Engineering and Business Solutions Private Limited, Bangalore (IN)

(72) Inventors: Rutika Harnarayan Lahoti, Akola (IN); Apitha Balasubramanian, Coimbatore (IN); Sunderasan Geethanathan, Tirupattur (IN)

(21) Appl. No.: 17/482,117

(22) Filed: Sep. 22, 2021

(30) Foreign Application Priority Data
Sep. 23, 2020 (IN) 202041041226

(51) Int. Cl. G06F 3/01; G06N 3/04

(52) U.S. Cl. CPC G06F 3/017; G06N 3/04

(57) ABSTRACT

A gesture recognition device includes a sensor unit having at least one sensor and a controller connected to the sensor unit. The controller is operable in a training mode and a trained mode. When the controller is operated in training mode, the controller is configured to allow selection of a domain followed by at least one of a selection and a creation of corresponding gestures using a domain module. The controller in the training mode is further configured to receive input signals from the sensor unit for the corresponding gestures, to apply a filter module corresponding to the selected domain to generate filtered datasets, and to train a gesture engine based on the filtered datasets. When the controller is operated in the trained/identification mode, the controller is configured to identify the gesture.

This application claims priority under 35 U.S.C. § 119 to patent application no. IN 2020 4104 1226, filed on Sep. 23, 2020 in India, the disclosure of which is incorporated herein by reference in its entirety.

The disclosure relates to a controller for gesture recognition and a method thereof.

### BACKGROUND

According to a prior art US2017344859, a method and system for providing gesture recognition services to user applications is disclosed. A method for providing gesture recognition services to a user application, comprising: storing sets of training data in a database at a server, the training data received from a sensor associated with the user application, the training data being indicative of characteristics of a gesture, the user application running on a client device; training a gesture recognition algorithm with the sets of training data to generate a trained gesture recognition algorithm, the output of the trained gesture recognition algorithm being an indication of the gesture; storing the trained gesture recognition algorithm in a client library at the server; receiving raw data from the sensor via the user application and storing the raw data in the client library; applying the trained gesture recognition algorithm to the raw data; and, when the trained gesture recognition algorithm recognizes the gesture, sending the indication of the gesture from the client library to the user application.

### SUMMARY

According to an exemplary embodiment of the disclosure, a gesture recognition device comprises a sensor unit comprising at least one sensor, and a controller connected to the sensor unit and configurable in a training mode and a trained mode. When the controller is configured in the training mode, the controller is configured to receive a selection of a domain followed by at least one of a selection of corresponding gestures and a creation of corresponding gestures, receive first input signals from the sensor unit for the corresponding gestures, apply a filter module corresponding to the selected domain to generate filtered datasets, and train a gesture engine based on the filtered datasets. When the controller is configured in the trained mode, the controller is configured to detect a domain of operation, receive second input signals from the sensor unit corresponding to a gesture of the detected domain, generate a corresponding filtered dataset from the second input signals using the filter module corresponding to the detected domain, and process the corresponding filtered dataset through the gesture engine and identify the gesture of the detected domain.

According to another exemplary embodiment of the disclosure, a method for recognizing a gesture using a controller of a device, the device comprising a sensor unit including at least one sensor connected to the controller, the method comprising operating the controller in a training mode including: receiving a selection of a domain followed by at least one of a selection of corresponding gestures and a creation of corresponding gestures, receiving first input signals from the sensor unit for the corresponding gestures, applying a filter module corresponding to the selected domain to generate filtered datasets, and training a gesture engine based on the filtered datasets. Operating the controller a trained mode includes: detecting a domain of operation; receiving second input signals from the sensor unit corresponding to a gesture of the domain, generating a corresponding filtered dataset from the second input signals using the filter module corresponding to the detected domain, and processing the filtered dataset through the gesture engine and identifying the gesture of the domain.

### BRIEF DESCRIPTION OF THE DRAWINGS

An embodiment of the disclosure is described with reference to the following accompanying drawings,

FIG. 1 illustrates a block diagram of a gesture recognition device, according to an embodiment of the disclosure;

FIG. 2 illustrates a block diagram of the gesture recognition device with an external sensor unit, according to an embodiment of the disclosure, and

FIG. 3 illustrates a flow diagram of training and identification of gesture, according to the disclosure.

### DETAILED DESCRIPTION

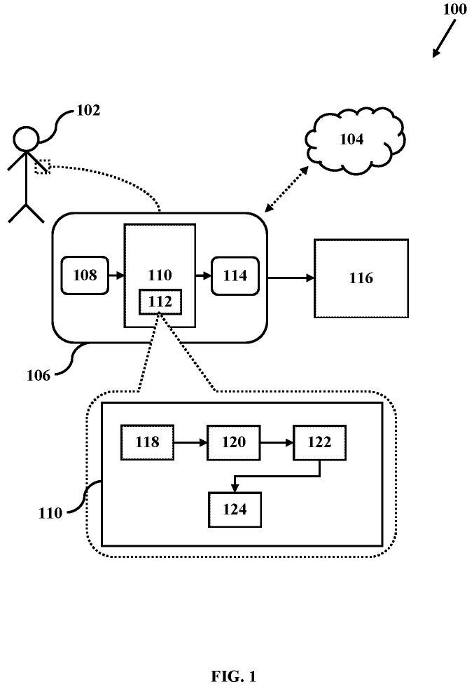

FIG. 1 illustrates a block diagram of a gesture recognition device, according to an embodiment of the disclosure. A system 100 is shown where the use of the device 106 is envisaged, however the device 106 is usable in different application as explained later. The device 106 comprises a sensor unit 108 comprising at least one sensor, and a controller 110 connected to the sensor unit 108. The controller 110 operable in any one of a training mode and a trained/identification mode, characterized by, while the controller 110 is operated in training mode, the controller 110 configured to allow selection of domain followed by any one of, selection and creation of (to set), corresponding gestures using a domain module 118, receive input signals from the sensor unit 108 for the set gesture, apply filter module 120 (also known as domain filter or data filter) corresponding to the selected domain to generate datasets 122, and train a gesture engine 124 based on the filtered datasets 122.

Further, while the controller 110 is operated in the trained/identification mode, the controller 110 configured to detect the domain of operation of the device 106, receive input signals from the sensor unit 108 corresponding to gestures of the domain, generate filtered datasets 122 from the input signals using the filter module 120 corresponding to the domain, and process the filtered datasets 122 through the gesture engine 124 and identify the gesture.

In accordance to an embodiment of the disclosure, the gesture engine 124 is modeled based on Sequential or Recurrent Neural Network (SNN/RNN), but not limited to the same. The RNN is a deep learning network which uses three dense layers comprising input layer, hidden layer and output layer. The hidden layer is a linear dense layer. The controller 110, based on the identified gesture, configured to enable any one of analysis of gesture, and control functions of any one selected from a group comprising an apparatus 116 and the device 106. Further, the filter module 120 configured to process data and generate datasets 122 through Recurrence Quantification Analysis (RQA) module and Minimum Redundancy Maximum Relevance (mRMR) module, but not limited to the same.

In accordance to an embodiment of the disclosure, the processing by the filter module 120 in the training mode is described. The filter module 120 is configured to record the time series data of the input signals from the sensor unit 108, and split the received data as per a pre-determined window size. The filter module 120 then applies the RQA on split training data followed by application of mRMR to calculate the relevance parameter when it is maximum. Similarly, in the trained/identification mode, the filter module 120 is configured to record the time series data of the input signals from the sensor unit 108, and apply RQA and mRMR on the time series data as per the window size, and apply classification on the output of RQA and mRMR to identify relevant gesture. The filter module 120 also shifts time series data as per window size (configurable) for continuing the processing of the incoming data samples in the input signals. The filter module 120 enables the analysis of data pattern in the input signals for multivariate or univariate data. In general, the filter module 120 is adapted/configured to filter the most significant data from the sensor unit 108 based on the domain using a machine learning feature classification technique, and detect a trigger point of change in the trained/identification mode to find the data window at which the gesture begins to occur in the continuous data stream.

The filter module 120 is configured to classify the data received through the input signals into two types (not limited thereto) comprising gesture data and Activities of Daily Living (ADL) data. The ADL data is also captured along with gesture data. For example, the filter module 120 is trained with pre-determined (say twenty) samples for each gesture data and twenty samples for ADL data. Further, repetitive twenty sets of such twenty samples are used to train the filter module 120 (four hundred samples for each gesture). The window size is twenty and window step/shift size is kept two, such that eighty percent of overlap is maintained. The windowing is performed in a manner that gestures occurring between windows is not missed.

Within the filter module 120, the RQA module generates various metrics for analysis, such as Recurrence Rate (RR) and Transitivity (T), and mRMR module generates Relevance, Redundancy (R & R) factors considered to identify gestures from the ADL. The Recurrence Rate metric gives the density of observed data points when plotted. The Recurrence Rate determines the density of distribution of sensor data points of the sensor unit 108. A mapping is arrived for the distribution of recurrence values for each gesture performed and then is used as an additional classification parameter to identify the gesture. The Transitivity metric gives the probability that two points of the phase space trajectory neighboring a third are also directly connected. The Transitivity is used to understand the variation of range of sensor data for each gesture, which helps in picking the right window from the stream of sensor data. The Relevance factor is determined from each window from the stream of data. Based on actual gestures, a window from before and after gesture is collected. The Relevance factor from the data stream is collected to determine if the same trend of movement is performed before the gesture of interest. Thus, the gesture is identified relevant to the training done for the gesture. The Redundant factor in combination with Relevance factor to eliminate redundant sensor data from the window of interest. The determined RR, T, and R & R values form as input to classify gestures from ADL. The parameter and factors are calculated for every sensor axis in the sensor unit 108. A table below, which is just an example, is used for deciding or selecting specific data to form datasets 122. The following table is just for explanation and the disclosure is not limited to the same.

| Gesture ID | Sensor ID | RR | T | R & R |
|---|---|---|---|---|
| 1 | SNC 1 | X, X1, X2, X3 | Y1, Y2, Y3 | Z, Z1, Z2, Z3 |
| 1 | Acc X | X6, X6, X8 | Y9, Y11, Y12 | Z12, Z13, Z14 |
| 1 | Gyr Y | . . . | . . . | . . . |
| 2 | Elastic | . . . | . . . | . . . |
| | Capacitance | | | |
| 3 | AccY | . . . | . . . | . . . |

The controller 110 is an Electronic Control Unit to process signals received from sensor unit 108. The controller 110 comprises memory 112 such as Random Access Memory (RAM) and/or Read Only Memory (ROM), Analog-to-Digital Converter (ADC) and vice-versa Digital-to-Analog Convertor (DAC), clocks, timers and a processor (capable of implementing machine learning) connected with the each other and to other components through communication bus channels. The aforementioned modules are logics or instructions which are stored in the memory 112 and accessed by the processor as per the defined routines. The internal components of the controller 110 are not explained for being state of the art, and the same must not be understood in a limiting manner. The controller 110 may also comprises communication units to communicate with a server or cloud 104 through wireless or wired means such as Global System for Mobile Communications (GSM), 3G, 4G, 5G, Wi-Fi, Bluetooth, Ethernet, serial networks and the like.

In an embodiment, the controller 110 and thus the device 106 provides only the training mode. In another embodiment, the controller 110 and thus the device 106 provides only the trained/identification mode. In yet another embodiment, the controller 110 and thus the device 106 provides both the training mode and trained mode and is selectable as per the requirement.

In accordance to an embodiment of the disclosure, the device 106 is selected from a group comprising a wearable device such as smartwatch, smart ring, a smart band, a portable device such as a smartphone, a dedicated sensor module, and the like. The wearable device is also possible to be worn on suitable body part of a user 102 based on the requirement, without any specific limitation, such as hand, arm, leg, foot, head, torso and the like. Similarly, the apparatus 116 is selected from any one of an home appliance such as Oven, Mixer grinder, Refrigerator, Washing machine, Dish washers, induction cooker, stoves and the like, and consumer electronics such as music system, Television, Computer, Lighting, a monitor with Graphics Processing Unit (GPU), gaming consoles (such as PlayStation™ XBOX™ Nintendo™, etc., projector, and cloud 104 and the like. The apparatus 116 are considered to be connectable to the device 106 over a communication channel such as wireless or wired. For example, Wi-Fi, Bluetooth, Universal Serial Bus (USB), Local Area Network (LAN), etc.

The at least one sensor of the sensor unit 108 comprises a single axis or multi-axis accelerometer sensor, single axis or multi-axis gyroscope, an Inertial Measurement Unit (IMU), Surface Nerve Conduction (SNC) sensor, a stretch sensor, capacitance sensor, sound sensor, magnetometer and the like.

The system 100 of FIG. 1 comprises a user 102 having the device 106 with built-in sensor unit 108. The device 106 comprises a screen 114 which is optional. Further, the system 100 also comprises the apparatus 116 which needs to be controlled. A working of the device 106 is now explained with respect to the training mode. The user 102 either holds or wears the device 106. The user 102 activates an application, pre-installed in the device 106, and selects a specific domain, such as home appliance, from the domain module 118. The domain module 118 comprises a configurator module (not shown) and a selector module (not shown). The configurator module enables the user 102 to select the domain in which the device 106 is to be operated, followed by, selection or creation of specific action for the domain. For example, a volume up/down for consumer domain or lever ON/OFF for industry domain, a temperature increase/decrease for consumer domain, a knob rotation in clockwise (CW)/Counter-clockwise (CCW) direction for consumer domain, etc. In other words, the configurator module triggers and assists in application of respective and suitable filtering using the filter module 120 on the input signals, which then passes the filtered datasets 122 for training. The configurator module is provided under training mode, and is used through the application installed in the device 106, and the device 106 is connected to the apparatus 116. The input signals from the sensor unit 108 which contains the data samples, are transferred in real-time to the gesture engine 124 running in the device 106 itself or in the apparatus 116, in order to perform training of data samples received from the user 102. The outcome of the configurator module enables the user 102 to train user 102 preferred gestures for control actions on control apparatuses 116.

The selector module allows the user 102 to link the selected action to a specific gesture such as fingers movement, hand movement, wrist movement, etc. The selector module enables the user 102 to shortlist a set of well-known signs or dynamic gestures related to the specific domain where the gesture are intended to be implemented. The domain gestures are pre-trained for the specific domain and are usable with and without any further training. Alternatively, the controller 110 allows the user 102 to define a new gesture altogether in addition to the pre-trained gestures. In still another alternative, the controller 110 allows the user 102 to train the pre-trained gestures, if needed. The controller 110 is configured to be able to train discrete and continuous gestures in order to use the same across different applications, such as gestures in consumer domain to be used in industry or medical domain, etc. Based on the gesture domain/category, the corresponding input signals from the sensor unit 108 are filtered for training. Thus, the device 106 is domain agnostic and usable across various needs. The domain sensor table with action impact is depicted below and is extendible to other domains without departing from the scope of the disclosure.

| Domain | Sensor | Action Impact |
|---|---|---|
| Consumer | Accelerometer | Control of Power ON, OFF, Volume control |
| Electronics | Gyroscope | of the paired appliance. |
| | | Control of UI by scrolling, selecting features |
| | | on display. |
| | | Virtually turn knob for selection and feature |
| | | control. |
| Medical | Biomechanical | Record the correctness of the fitness gesture |
| | SNC (Fingers) | Classify and record the duration, number of |
| | Stretch Sensor | actions and sequence of gestures |
| | (Physiotherapy) | Retrieve history of repeat |
| Industry | Accelerometer | Control ON/OFF of start/stop buttons |
| | Gyroscope | Push Pull lever controls |
| | Stretch sensor | Scroll and select features on Human Machine |
| | | Interface (HMI) controls |
| Gaming | Sound sensor | Record the movement pattern of hand and |
| | | wrist |
| | Stretch sensor | Retrieve history of pattern |

After the required action and the corresponding gesture are set, the user 102 makes the gesture and the controller 110 starts receiving the input signals from the sensor unit 108. In an embodiment, the controller 110 guides the user 102 through an animation on a display screen 114 of the device 106 or of the apparatus 116. The received input signals from the sensor unit 108 are then processed by the filter module 120. The filter module 120 performs feature extraction by picking up the right feature data for the training and uses the same technique also in the trained mode. The classification of gestures is based on the domain selected by the user 102. Some of the domain comprises but not limited to consumer electronics, medical, Industry, Sports, etc. The filter module 120 is modeled with intelligence to pick the required features based on the domain, which selects the respective axis and input signals of the sensor unit 108 on sensing the orientation of the hand of the user 102 and the selected domain, correspondingly.

The consumer electronics domain comprises “hand-wrist” gestures for User Interface (UI) control, Augmented Reality (AR) applications, Virtual Reality (VR) applications, which comprises following functions, knob rotation (CW, CCW), scrolling fast and slow (up, down, left, right), select signs (tapping), number pattern/alphabets in languages, volume up/down selectors, power ON/OFF selectors and the like. The same is elaborated in below table.

| Sl. No | Function | Sensors | Filter module 120 |
|---|---|---|---|
| 1 | Appliance | Accel- | The filter module 120 senses the normal |
| | Knob | erometer | position of the user 102 in order to |
| | Rotation | | determine the orientation from the user |
| | Clock | | behavior. Based on the concluded |
| | Appliance | | orientation, the corresponding axis value |
| | Knob | | is pulled up for training during the |
| | Rotation | | clockwise and anticlockwise turn |
| | Counter | | by turn of the wrist and palm. |
| | Clockwise | | Speed is decided by the magnitude |
| | | | effect on the turn and the turn |
| | | | direction decides the values. |
| | | | Features extracted is rotation speed |
| | | | and rotation direction. |
| 2 | Scroll | Gyroscope | The rate of change in movement of the |
| | screen- | | hand is recognized using the wave of |
| | right left | | the hand which is used to detect the |
| | up and | | axis of movement. |
| | down | | Feature extracted include wave speed |
| | Volume | | and direction of the hand. |
| | Up and | | |
| | Down | | |
| | Power Up | | |
| | and Down | | |
| 3 | Dynamic | Accel- | Drawing patterns include straight and |
| | number | erometer | curved lines. The orientation of the user |
| | signs | Gyroscope | 102 tend to change across axis during |
| | | | scripting of certain characters like |
| | | | “s”. Thus all axis data is picked for |
| | | | training and pattern recognition. |
| | | | Feature extraction includes rate of |
| | | | change of axis for understanding speed |
| | | | of hand movement, coordinate value |
| | | | interpretation at regular sample time |
| | | | to understand the hand movement in |
| | | | a 2 dimensional (2D) space. |
| 4 | Fast scroll | Gyroscope | Based on the speed of the hand |
| | flip | | movement, the rate of change of the |
| | | | sensor data is detected. This is used to |
| | | | determine the fast flip gestures of the |
| | | | hand which are used to flip pages by |
| | | | flip gestures, flip through end of the list |
| | | | in a user interface, flip a rotating |
| | | | interface for multiple rotations. |

The Medical domain includes “arm-hand-wrist-finger” gestures for physiotherapy—SNCs, accelerometer, etc., which comprises occupational physiotherapy comprising wrist stretching and relaxing (straight, up and down), forearm strengthening, fitness and regularization (palm up and down to earth), finger stretch and relax (palm open and close), etc. The same is elaborated below table.

| Sl. | | | |
|---|---|---|---|
| No | Function | Sensors | Filter module 120 |
| 1 | Wrist rotate | Accelerometer | Based on the domain, the filter |
| | clockwise | Stretch sensor | module 120 verifies the input |
| | Wrist rotate | | signals from the sensor unit |
| | counter | | 108 of right tension in the |
| | clockwise | | wrist and palm using signals |
| | | | from the stretch sensor. |
| | | | The features include wrist |
| | | | tension, speed of rotation and |
| | | | direction. |
| 2 | Wrist Stretch | Stretch Sensor | Feature includes wrist tension |
| | Up | | or relaxation states and levels |
| | Wrist Stretch | | |
| | down | | |
| | Finger Stretch | | |
| | Finger Relax | | |
| 3 | Arm rotate | Accelerometer | Feature includes the |
| | Clockwise | Gyroscope | rotation speed and direction |
| | Arm rotate | | of the arm |
| | Counter | | |
| | Clockwise | | |

For Industry gestures, the functions comprises lever operation state control (ON/OFF State), button state control (ON/OFF State), knob rotation (knob state adjustment), start/stop control, and the like. The same is elaborated in below table.

| Sl. No. | Function | Sensors | Filter module 120 |
|---|---|---|---|
| 1 | Knob Rotation | Accelerometer | The filter module 120 detects the normal |
| | Clock | | position of the user 102 in order to determine |
| | Knob Rotation | | the orientation from the user behavior. Based on |
| | Counter | | the concluded orientation, the corresponding |
| | Clockwise | | axis value is pulled up for training during the |
| | dynamic | | clockwise and anti-clockwise turn by turn of the |
| | gesture | | wrist and palm. |
| | | | Speed decides the magnitude effect on the turn |
| | | | and the turn direction decides the values. |
| | | | Features extracted is Rotation speed and |
| | | | rotation direction. |
| 2 | Lever | Gyroscope | Feature includes hand grip and direction of |
| | Operation ON | Stretch Sensor | hand movement. |
| | Lever | | |
| | Operation OFF | | |
| 3 | Button ON | Accelerometer | Feature includes the movement speed and |
| | Button OFF | Gyroscope | direction of the palm and wrist |
| | Start | | |
| | Stop | | |

The gaming functions comprises playing pattern, hit patterns (wrist down, wrist rotate, hand grip intensity), cricket batting and bowling and fielding, shuttling, running, jumping, skipping, rowing, skating, fencing and the like. The same is elaborated in below table. The below table includes examples for a few domain functions and gestures and are extendable to as many standard discrete and continuous gestures and hand movements in an actual implementation.

| Sl. No | Function | Sensors | Filter module 120 |
|---|---|---|---|
| 1 | Cricket | Accelerometer | Feature includes hand grip, hand |
| | batting | Gyroscope | flying pattern, speed and |
| | Shuttle | Stretch sensor | direction within a specific interval |
| | Handling | Sound sensor | |
| | Bowling | | |

The filter module 120 processes the input signal as per the selected gesture and generates datasets 122. In other words, the datasets 122 is the filtered output of the filter module 120. The datasets 122 are passed to the gesture engine 124 in the training mode for training. The gesture engine 124 uses the SNN with at least three layers. The first layer is the input layer which has real time filtered data for the gesture with temporal values. This is passed to a fully connected hidden layer which a dense layer converting the parameters to multiple (such as five hundred) mapped values based on rectified linear activation, without the need of long or short term memory. It is the training of the current training cycle with no feedback or feedforward mechanism in the network that remembers any data from past. The data is directly passed to the output layer which decides a weightage for every classification output from the neural network. Finally the gesture engine 124 is trained. The trained gesture engine 124 is used as it is, or a downloadable version of trained gesture engine 124 is generated (also known as predictor module) based on the weights of the training dataset 122 which is used in identification mode for identifying the real-time gesture.

In an embodiment, the controller 110 provides a guiding track on the screen 114. The guiding track enables the user 102 to understand the pattern of the gesture and also make some trials on top of the guiding pattern thus allowing small calibrations needed specific to the user 102. The dataset 122 collected over this training session is sent over to the filter module 120 for further dimension reduction checks and then actual feature data is sent for training the gesture engine 124. The controller 110 is configured to display the recorded gesture on the display screen 114 for the confirmation of the user 102. The display screen 114 is shown to be in the device 106. In another embodiment, the display screen 114 is provided in the apparatus 116. In yet another embodiment, the display screen 114 is provided in both the device 106 and the apparatus 116. The controller 110 performs gesture playback through an animation, visible in the display screen 114. Alternatively, the controller 110 sends the commands corresponding to the identified gesture to the apparatus 116. Along with the command data, a video/animation of the gesture is also sent to capable apparatus 116 in order to show the simulation of the gesture for the particular domain command on the display screen 114 of the apparatus 116. The display of animation is optional based on the capability of the apparatus 116 and/or the device 106.

Once the training is about to be completed and if the device 106 or the apparatus 116 is capable, the controller 110 runs a three dimensional gesture playback to confirm the user 102 about the trained gesture. The playback is used in the trained/identification mode as a sprite or the VR object to bring the effect of an actual hand performing the operation virtually on the apparatus 116, if there is a possibility.

In an alternative working of FIG. 1, the controller 110 sends the received input signals to the cloud 104. A control unit residing in the cloud 104, which is similar to the controller 110 then processes the input signals received from the controller 110. Here, the role of the controller 110 is to transmit the received inputs signals to the cloud 104. The remaining processing up to training the gesture engine 124 remains the same. An installable version of the trained gesture engine 124 is downloaded and deployed in the controller 110. In yet another alternative, the controller 110 and the cloud 104 together share the processing of the input signals. The trained gesture engine 124 is then received back from the cloud 104 to the device 106.

In the training mode, the sensing unit 108 detects all movements made by the user 102 through wrists, forearm and fingers. A pivot point of the movement by the user 102 is the elbow, not limited to the same. The movements of the hand comprises rotating of wrist clockwise, anticlockwise, and waving of the wrist leftwards and rightwards, finger snap, finger coordinated rotations, etc. The controller 110 is able to detect the movement of the hands as per the discrete gestures and control functions of the device 106 or any User Interface (UI) or the apparatus 116. The control function or the UI is of an installed application, the home appliance, and the consumer electronics, etc., as already disclosed above. The sensing unit 108 is either built-in within the device 106 or is capable of being externally interfaced with the device 106.

An example is provided for explanation. The user 102 wears the device 106 which is a smartwatch and intends to control the apparatus 116 which is an oven. The oven is provided with a display screen 114. First, the user 102 connects the smartwatch to the oven over a one-to-one Bluetooth connection or over a local wireless network using a router. The user 102 then opens the application in the smartwatch and opens the configurator module and selects the control actions such as temperature control. The user 102 then opens the selector module and then configures/links the control actions to specific gesture such as finger coordinated rotation in CW for increase and CCW for decrease. The configuration module and the selector module are part of domain module 118. Only one control action and gesture is explained for simplicity, and the user 102 is allowed to configure other controls as well. Once set, the user 102 performs the gesture, the real-time signals for which are processed by the filter module 120, as already explained above. The filter module 120 processes the signals using the RQA and mRMR modules and calculates parameters and factors. Based on the occurrence of the parameters, factors, and comparison of the same with respective threshold saved in the memory 112, only selected input signals are used to generate datasets 122 for training. Based on the domain, different sets of information is considered from the same sensor. The datasets 122 are sent to the gesture engine 124 for training. The gesture engine 124 either resides in the controller 110 or in the cloud 104. The identified gesture is displayed on the screen 114 of the oven. If satisfied, then the user 102 proceeds with other gestures. The training mode ends with the completion of training of all the needed gestures (pre-defined or user-defined).

A working of the device 106 is explained with respect to trained/identification mode. Consider the device 106 is pre-installed with the trained gesture engine 124. Alternatively, the user 102 trains the gesture engine 124 as explained earlier. The user 102 connects the device 106 to the apparatus 116. The connection is preferably over wireless communications means between the device 106 and the apparatus 116, such as Bluetooth™, Wi-Fi, ZigBee, InfraRed (IR) and the like, however the connection is possible to be made over wired communication means as well, such as Local Area Network (LAN), Universal Serial Bus (USB), Micro-USB, audio jack cable and the like. The user 102 makes the connection by activating the application installed in the device 106. Once the connection with the apparatus 116 is established, the domain is automatically detected based on the apparatus 116 information retrieved during connection, and the controller 110 is ready to receive the inputs signals from the sensor unit 108. The user 102 makes the gestures, the input signals for which is processed by the filter module 120. The filter module 120 selectively processes the input signals based on the detected domain. The filter module 120 generates domain specific datasets 122, which is then sent to the trained gesture engine 124 for identification of gesture. Once identified, the gesture specific action is performed in the apparatus 116. For example, the user 102 wears the smartwatch as the device 106 and connects to the oven. The user 102 makes the gesture of clockwise rotation of fingers holding an imaginary knob, the corresponding action in the apparatus 116, such as increase of a temperature, is performed. Only one gesture is explained for simplicity, and the same must not be understood in limiting sense. The user 102 is also able to navigate between two knobs of the oven, one for temperature and other for setting time, etc.

In the trained/identification mode, the trained gesture is used to control real time apparatus 116 such as appliances, UI of an application installed in phones, the smartphone, home automation systems, entertainment systems, etc. The control happens over communication channel established between the device 106 and the external apparatuses 116. The domain module 118 and the filter module 120 are used to interpret the input signals received from the sensor unit 108 into an interpretable gesture. Both the modules also converts the continuous data into window of interest. Further, gesture engine 124 is used for training and prediction using the generated datasets 122.

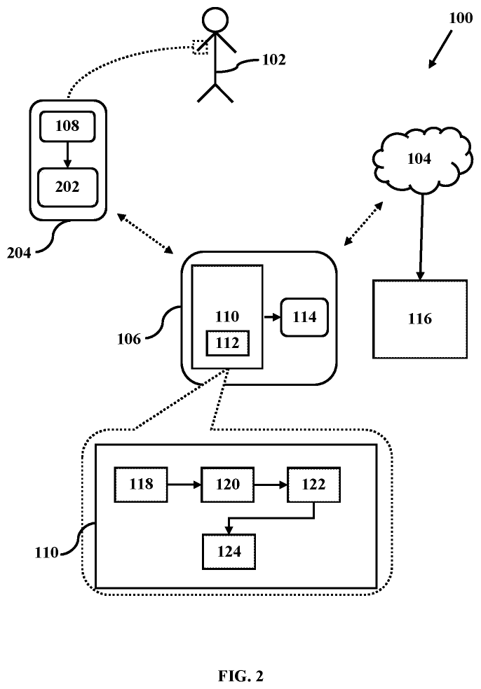

FIG. 2 illustrates a block diagram of the gesture recognition device with an external sensor unit, according to an embodiment of the disclosure. The working of the device 106 with an External Sensor Unit (ESU) 204 is similar to as explained in FIG. 1. The ESU 204 comprises the sensor unit 108 in connection with an Interface Control Unit (ICU) 202 to establish communication with the controller 110 or the device 106. The ICU 202 comprises the wired or wireless communication means to connect with the controller 110. The device 106, the ESU 204 and the cloud 104 are either part of a common network, or the device 106 is connectable to each through separate means. For example, the device 106 is connected to the ESU 204 through Bluetooth™, and connected to the cloud through Wi-Fi or telecommunication systems such as GPRS, 2G, 3G, 4G, and 5G etc.

A working of the device 106 as per FIG. 2 is envisaged based on an embodiment below but not limited to the same. Consider the user 102 is a physiotherapist assisting a patient. While doing a therapy or massage or acupressure, the user 102 wears a glove fit with the ESU 204, specifically having the stretch sensor, pressure sensor, etc. The user 102 connects the ESU 204 to the device 106 such as the smartphone and starts giving the therapy. The input signals detected from the ESU 204 are transmitted to the controller 110, which processes the signals and displays on the screen 114 or to the screen of the apparatus 116 (such as a monitor) remote from the location of the user 102. In one scenario, the trained gesture engine 124 is adapted to instruct the user 102 to give a specific type of force/pressure or stretch to the muscle of the patient. In another scenario, a specialist sitting in remote location guides (over a phone) the user 102 by observing the actual gesture on the screen 114, in which case the cloud 104 enables the transmission and reception of the signals between them.

Another working example of another embodiment is provided. Consider the user 102 is a batsman in a game of cricket. The batsman wears the ESU 204 in hand, helmet and legs. A coach of the cricketer is not just able to monitor the strokes, but stance and head position as well. The coach is able to give feedback later (or real time) to improve the performance of the batsman. The same applies to a bowler and fielder as well. Another example comprises sticking the ESU 204 to the bat and analyze or monitor the strokes or power of the strokes by the batsman. The above example is possible by directly wearing the device 106 such as smartwatch instead of the ESU 204.

In accordance to an embodiment of the disclosure, the controller 110 is configured to detect a finger snap using the filter module, followed by connecting the device 106 to nearest apparatus 116 over the communication channel.

According to the disclosure, a dense fully connected neural network based gesture recognizing wearable usable with controller 110 in both trained and training mode is provided. The controller 110 focusses on classification using combination of sensors such as accelerometer, gyroscope, stretch sensors, pressure sensors, etc., based on chosen domain of gestures. The controller 110 uses filter module 120 before the datasets 122 are passed for training. The filter module 120 are applied based on domain and sensor data considering the orientation of the user 102. The filter module 120 effectively removes the outliers in the datasets 122 thereby sending only effective data for classification using the sequential linear neural network, thus no long term dependency in the network. The device 106 provides the controller 110 which performs feature extraction and creation of dataset 122. The controller 110 preprocesses the input signals based on the orientation of wrist and hands using sensor fusion technique (based on accelerometer, gyroscope, stretch sensing and biomechanical surface sensors and the like). The controller 110 identifies the domain and orientation in the preprocessing and sends selective features, recorded as datasets 122, for training to the neural network based gesture engine 124. Specifically, time sliced shaping of the data of the input signals from the sensor unit 108, for the discrete gestures are sent to the gesture engine 124. The controller 110 is able to recognize gestures in run/real time using the linear sequential three layer dense neural network without the Long Short Term Memory (LSTM). The gesture engine 124 is trainable and also predicts based on discrete or continuous gestures. The gesture engine 124 is deployable in the controller 110.

The controller 110 is responsible for live data collection using the built-in or externally interfaced sensor unit 108 to detect discrete and continuous gestures and movements of the user 102. During the training mode, the movements are those with elbow pivoted/freehand and the wrist, palm and fingers moving together. During the trained mode, the movements are freehand. The collected data from the sensor unit 108 is transmitted over communication channel.

The installed application performs data preprocessing to recognize standard patterns of hand and wrist movements. This is done locally close to the device 106 in order to be able to interact freely with the user 102 to get multiple data samples for data analysis and sensor data interpretation. As already mentioned, the sensor unit 108 is either built-in inside the device 106 or is external of the device 106.

The gesture engine 124 is used to train sensor values and create feature labels based on expectations of the user 102. The gesture engine 124 resides in the controller 110 or in the cloud 104. In case of the cloud 104, the cloud 104 is capable to convert the gesture engine 124 to a smaller footprint that contains only the prediction logic to be installed in the controller 110. The converted gesture engine 124 remains as an asset that is easily replaceable on the controller 110 after training.

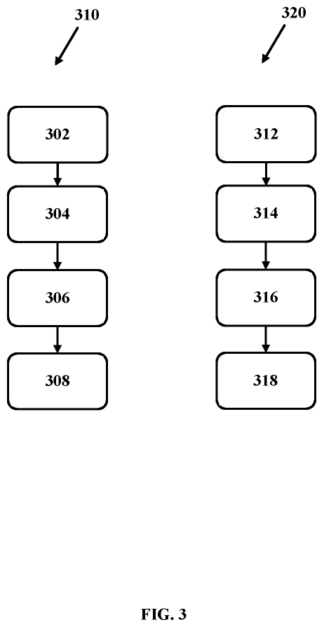

FIG. 3 illustrates a flow diagram of training and identification of gesture, according to the disclosure. The flow diagram illustrates a method for recognizing gesture by the controller 110 in a device 106. The device 106 comprises, the sensor unit 108 comprising at least one sensor, and the controller 110 connected to the sensor unit 108. The controller 110 operable in any one of the training mode and the trained/identification mode. A first flow diagram 310 explains the training mode. In the first flow diagram 310, the method is characterized by, while the controller 110 is operated in training mode, the method comprising the steps of, a step 302 comprising allowing selection of domain followed by any one of, selection and creation of, (setting) corresponding gestures. The domain selection is made by the user 102 where the user 102 is provided with options to select the standard domain based human controls. The guiding track in the domain module 118 guides the motion for the user 102 and the actual track is selected by the user 102 to perform trials for the data calibration. A step 304 comprises receiving input signals from the sensor unit 108 for the selected gesture. The input signals from the sensor unit 108 are collected for the discrete and/or continuous gestures or movements with the wrist and fingers or other parts of the body as required. A step 306 comprises applying filter module 120 corresponding to selected domain to generate datasets 122. The collected data is processed by the filter module 120 for analysis. The filter module 120 filters the collected data as per the orientation (frontal or traverse planes) of the device 106 and/or analyses the finger data based on biomechanical SNCs, if used. A step 308 comprises training the gesture engine 124 based on the filtered datasets 122. The gesture engine 124 is trained with the time discrete data for gestures, hand movements, finger movements, etc.

A second flow diagram 320 comprises a method for identification of gesture. The method is characterized by a step 312 comprising, detecting the domain of operation. If the user 102 connects to the apparatus 116, then the domain is automatically detected based on the information on type of apparatus 116 accessed during the establishment of the communication, such as consumer, medical, gaming, industry, etc. Alternatively, the user 102 inputs the domain manually in the device 106 through input means such as keypad, touch screen, etc. A step 314 comprises receiving input signals from the sensor unit 108 corresponding to gestures of the domain. A step 316 comprises generating filtered dataset 122 from the input signals using the filter module 120 corresponding to the domain. The filter module 124 comprises initiating windowing of the data based on the domain. The windowing performs filtering of actual gesture from hand, wrist, and finger gestures. A step 318 comprises processing the filtered dataset 122 through the gesture engine 124, where the classification of gesture is performed based on configured domain, and identify the gesture. Lastly, an action impact of the classified gesture is performed.

The gesture engine 124 is modeled based on Sequential/Recurrent Neural Network but not limited to the same. Based on the identified gesture, the method comprises any one of analyzing the gesture, and controlling functions of any one selected from a group comprising the apparatus 116 and the device 106. The filter module 120 comprises data processing and generation of datasets 122 through Recurrence Quantification Analysis (RQA) and Minimum Redundancy Maximum Relevance (mRMR) modules.

According to the disclosure, the device 106 comprises the sensor unit 108 connected to an Interface Circuit Unit (ICU) 202, together referred to as External Sensor Unit (ESU) 204. The ESU 204 is external to the controller 110. The controller 110 is connectable to the ESU 204 through any one of the wired and wireless communication means. The ESU 204 is either a wearable or provided in a manner to be adhered, for example to the apparatus 116 or to a skin of the user 102.

According to an embodiment of the disclosure, the gesture recognizing device 106 is provided. The device 106 comprises the sensor unit 108 comprising at least one sensor, and the controller 110 connected to the sensor unit 108. The controller 110 operable in any one of a training mode and a trained/identification mode. While the controller 110 is operated in training mode, the controller 110 configured to allow selection of domain followed by any one of, selection and creation of (to set), corresponding gestures using the domain module 118, receive input signals from the sensor unit 108 for the set gesture, apply the filter module 120 corresponding to the selected domain to generate datasets 122, and train the gesture engine 124 based on the filtered datasets 122. Further, while the controller 110 is operated in the trained/identification mode, the controller 110 configured to detect the domain of operation of the device 106, receive input signals from the sensor unit 108 corresponding to gestures of the domain, generate filtered datasets 122 from the input signals using the filter module 120 corresponding to the domain, and process the filtered datasets 122 through the gesture engine 124 and identify the gesture. The description for controller as explained in FIG. 1, FIG. 2 and FIG. 3 is applicable for the device 106 as well, and not repeated here for simplicity.

According to the disclosure, the controller 110 and the method enables low power consumption and storing of less data on the device 106 due to filter module 120, better accuracy, less latency time as only specific input signals from the sensor unit 108 are processed (less processing time) achieving focused operations. The user 102 is provided with option to select the domain gestures to minimize the training needs. The filter module 120 automatically performs windowing for the selected domain during training mode and trained mode. The device 106 comprises the training mode which enables training of new gestures for controlling apparatus 116. The device 106 comprises a three dimensional gesture playback feature which is available in both training mode and the trained mode. In the training mode, the animation is played on the screen 114 and the same is also transferred to the apparatus 116 which is controlled to bring the effect of the actual interaction being made on the screen 114.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A gesture recognition device, comprising:
a sensor unit comprising at least one sensor; and
a controller connected to said sensor unit and configurable in a training mode and a trained mode,
wherein when said controller is configured in said training mode, said controller is configured to:
receive a selection of a domain followed by at least one of a selection of corresponding gestures and a creation of corresponding gestures,
receive first input signals from said sensor unit for said corresponding gestures,
apply a filter module corresponding to said selected domain to generate filtered datasets, and
train a gesture engine based on said filtered datasets; and
wherein when said controller is configured in said trained mode, said controller is configured to:
detect a domain of operation,
receive second input signals from said sensor unit corresponding to a gesture of said detected domain,
generate a corresponding filtered dataset from said second input signals using said filter module corresponding to said detected domain, and
process said corresponding filtered dataset through said gesture engine and identify said gesture of said detected domain.

2. The gesture recognition device as claimed in claim 1, wherein said gesture engine is modeled based on a Sequential/Recurrent Neural Network.

3. The gesture recognition device as claimed in claim 1, wherein, based on said identified gesture, said controller is further configured to enable at least one of (i) analysis of said identified gesture, and (ii) control functions of an apparatus and/or said device.

4. The gesture recognition device as claimed in claim 1, wherein said filter module is configured to process data and to generate said filtered datasets through a Recurrence Quantification Analysis module and/or a Minimum Redundancy Maximum Relevance module.

5. The gesture recognition device as claimed in claim 1, wherein:
said sensor unit is connected to an interface circuit unit,
said sensor unit and said interface circuit unit together form an external sensor unit,
said external sensor unit is external to said controller, and
said controller is operably connected to said external sensor unit via a wired connection and/or a wireless connection.

6. A method for recognizing a gesture using a controller of a device, said device comprising a sensor unit including at least one sensor connected to said controller, said method comprising:
operating said controller in a training mode including:
receiving a selection of a domain followed by at least one of a selection of corresponding gestures and a creation of corresponding gestures,
receiving first input signals from said sensor unit for said corresponding gestures,
applying a filter module corresponding to said selected domain to generate filtered datasets, and
training a gesture engine based on said filtered datasets; and
operating said controller in a trained mode including:
detecting a domain of operation;
receiving second input signals from said sensor unit corresponding to a gesture of said domain,
generating a corresponding filtered dataset from said second input signals using said filter module corresponding to said detected domain, and
processing said filtered dataset through said gesture engine and identifying said gesture of said domain.

7. The method as claimed in claim 6, wherein said gesture engine is modeled based on a Sequential/Recurrent Neural Network.

8. The method as claimed in claim 6, further comprising:
based on said identified gesture, at least one of (i) analyzing said identified gesture, and (ii) controlling functions of an apparatus and/or said device.

9. The method as claimed in claim 6, further comprising:
using said filter module for data processing and generation of said filtered datasets through Recurrence Quantification Analysis and/or Minimum Redundancy Maximum Relevance modules.
